(19) United States
(12) Patent Application Publication
(10) Pub. No.: US 2016/0110069 A1
(43) Pub. Date: Apr. 21, 2016

(54) INFORMATION PROCESSING APPARATUS AND METHOD OF CONTROLLING INFORMATION PROCESSING APPARATUS

(71) Applicant: SHARP KABUSHIKI KAISHA, Osaka (JP)

(72) Inventor: Fumitoshi TANOUE, Osaka-shi (JP)

(21) Appl. No.: 14/888,962

(22) PCT Filed: Jun. 6, 2014
(86) PCT No.: PCT/JP2014/065128

§ 371 Date: Nov. 4, 2015

(30) Foreign Application Priority Data
Jun. 7, 2013 (JP) 2013-121170

(51) Int. Cl. G06F 3/0484; G06F 3/0482; G06F 3/0488

(52) U.S. Cl. CPC G06F 3/04842; G06F 3/04847; G06F 3/0488; G06F 3/0482; G06F 2203/04808

(57) ABSTRACT

A smartphone (1) of the present invention includes (i) an object specifying section (12) for, in a case where an operation determination section (11) has determined that a predetermined operation had been carried out, (a) specifying a predetermined range on a display screen based on a contact position and (b) specifying an object included in the predetermined range and (ii) an object storage section (13) for, in a case where the object has been specified, creating a folder storing the object thus specified.

### TECHNICAL FIELD

The present invention relates to an information processing apparatus including a touch panel. More specifically, the present invention relates to an information processing apparatus and a control program each for managing, with use of a folder, a plurality of objects and data which is associated with the plurality of objects.

### BACKGROUND ART

In an electronic device including a touch panel, collective management of various types of data in units of folders is widely carried out, as with a conventional personal computer (PC).

However, unlike the conventional PC, various inputs to the electronic device including a touch panel are generally carried out without using a mouse or a keyboard. Under the circumstances, there have been problems that a complicated operation is required when an operation to create a folder or an operation to select a file is carried out, as in the PC, in the electronic device including a touch panel.

Among the problems, Patent Literature 1 discloses a technique to simplify the operation to create a folder, that is, Patent Literature 1 discloses a technique in which, when an icon or the like of a file is dragged and dropped on an icon of another file or the like, the files associated with the icons or the like which overlap with each other by the drag and drop operation are collectively stored in a single folder.

Patent Literature 2 discloses a technique in which, when an icon of a folder is dragged and dropped on an icon of another folder, a new folder is created and shortcut files for files stored in the folder and the another folder are stored in the new folder.

Meanwhile, Patent Literature 3 discloses a technique for causing content displayed on a display screen to be selected when the content has been touched.

### CITATION LIST

### Patent Literatures

Patent Literature 1

Japanese Patent Application Publication, Tokukai, No. 2012-008916 A (Publication Date: Jan. 12, 2012)

Patent Literature 2

Japanese Patent Application Publication, Tokukai, No. 2005-198064 A (Publication Date: Jul. 21, 2005)

Patent Literature 3

Japanese Patent Application Publication, Tokukai, No. 2012-230527 A (Publication Date: Nov. 22, 2012)

### SUMMARY OF INVENTION

### Technical Problem

However, even with the techniques disclosed in Patent Literatures 1 through 3, it is impossible to simplify both of the operation to create a folder and the operation to select a file to be stored in the folder.

Specifically, the techniques disclosed in Patent Literatures 1 and 2 allow only up to two objects to be selected at one time from displayed objects (icons of files or folders). Accordingly, when many objects are to be stored in a folder, such objects need to be individually dragged and dropped, and this causes the operation to be less efficient.

Patent Literature 3 discloses a technique for selecting a plurality of objects, but does not disclose an operation to give instruction to carry out a process with respect to selected plurality of objects (i.e., a process for storing, in a folder, selected plurality of objects). Therefore, the selected plurality of objects need to be stored in an existing folder or a newly created folder.

The present invention has been made in view of the problems, and an object of the present invention is to provide an information processing apparatus and a control program each of which is capable of efficiently carrying out both of an operation to specify objects and an operation to store the objects in a folder, regardless of the number of objects to be specified.

### Solution to Problem

In order to attain the object, an information processing apparatus in accordance with an aspect of the present invention includes: a display section for displaying an object on a display screen; an input section for detecting a contact position of an indicator on the display screen; an operation determination unit for determining whether or not a predetermined operation has been carried out, the predetermined operation having starting points which are at least two contact positions that have been detected by the input section; a range specifying unit for, in a case where the operation determination unit has determined that the predetermined operation had been carried out, specifying a predetermined range on the display screen based on the at least two contact positions detected by the input section; an object specifying unit for, in a case where at least one object is included in the predetermined range specified by the range specifying unit, specifying the at least one object as a storage-target object; and an object storage unit for, in a case where the object specifying unit has specified the storage-target object, (i) creating a folder for storing an object and (ii) storing, in the folder, the storage-target object thus specified.

A control program in accordance with an aspect of the present invention is a control program for causing a computer to function as an information processing apparatus including (i) a display section for displaying an object on a display screen and (ii) an input section for detecting a contact position of an indicator on the display screen, the control program causing the computer to execute: an operation determination step of determining whether or not a predetermined operation has been carried out, the predetermined operation having starting points which are at least two contact positions that have been detected by the input section; a range specifying step of, in a case where it has been determined in the operation determination step that the predetermined operation had been carried out, specifying a predetermined range on the display screen based on the at least two contact positions detected by the input section; an object specifying step of, in a case where at least one object is included in the predetermined range specified in the range specifying step, specifying the at least one object as a storage-target object; and an object storage step of, in a case where the storage-target object has been specified in the object specifying step, (i) creating a folder for storing an object and (ii) storing, in the folder, the storage-target object thus specified.

### Advantageous Effects of Invention

According to the aspects of the present invention, it is possible to efficiently carry out both of an operation to specify objects and an operation to store the objects in a folder, regardless of the number of objects to be specified.

### BRIEF DESCRIPTION OF DRAWINGS

FIG. 1 is a block diagram illustrating a configuration of a substantial part of a smartphone in accordance with the present invention.

FIG. 2 shows an example of a data structure of a display list to be used by the smartphone.

FIG. 3 is a flow chart showing an example of a process to be carried out by the smartphone.

FIG. 4 shows, in (a) through (d), examples of (i) an operation to be carried out by a user with respect to the smartphone and (ii) a display screen.

FIG. 5 shows, in (a) through (d), other examples of (i) an operation to be carried out by a user with respect to the smartphone and (ii) a display screen.

FIG. 6 shows, in (a) through (d), still other examples of (i) an operation to be carried out by a user with respect to the smartphone and (ii) a display screen.

FIG. 7 shows, in (a) through (d), yet other examples of (i) an operation to be carried out by a user with respect to the smartphone and (ii) a display screen.

### DESCRIPTION OF EMBODIMENTS

### Embodiment 1

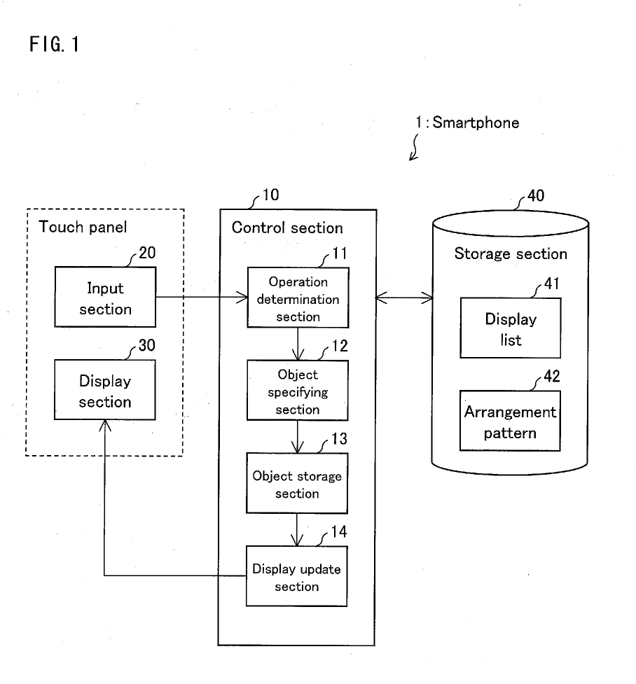

The following description discusses Embodiment 1 of the present invention with reference to FIGS. 1 through 4. Embodiment 1 describes an example in which an information processing apparatus in accordance with the present invention is realized by a smartphone. Note, however, that a form in which the present invention is realized is not limited to the smartphone. The present invention is applicable to any information processing apparatus in any size, provided that such information processing apparatus is capable of (i) displaying an object on a display screen, (ii) accepting an operation carried out by a user with respect to the object, and (iii) managing data by storing the data in a folder in the information processing apparatus.

<<Configuration of Substantial Part>>

First, the following description discusses a configuration of a substantial part of the smartphone with reference to FIG. 1. FIG. 1 is a block diagram illustrating a configuration of a substantial part of a smartphone 1 (an information processing apparatus). Note that a configuration which is not directly relevant to a configuration of the invention is omitted in FIG. 1. Note, however, that the smartphone 1 can include the omitted configuration in accordance with actual conditions of implementation.

The smartphone 1 is a device which includes a touch panel and is capable of displaying at least one object on the touch panel. Further, the smartphone 1 is a device capable of accepting an operation carried out by a user with respect to an object, specifically, an operation to select an object.

Note that it is only necessary that the object (i) be to be selected by a user and (ii) be associated in advance with a specific process or data. Specific examples of the object encompass (i) shortcut icons for an application and various functions which are provided in the smartphone 1 and (ii) icons indicating various files and folders.

The smartphone 1 is a device capable of managing data by storing, in a folder, the data with which the object is associated.

As illustrated in FIG. 1, the smartphone 1 includes a control section 10, an input section 20, a display section 30, and a storage section 40. Note that an input surface of the input section 20 and a display surface of the display section 30 are integrally provided as the touch panel.

The display section 30 displays an image in accordance with control carried out by the control section 10. Examples of the display section 30 encompass a flat display panel such as a liquid crystal panel and an organic EL panel. The display section 30 displays an object on the display screen in accordance with information received from a display update section 14 (described later).

The input section 20 accepts a touch input carried out by a user with respect to the smartphone 1. More specifically, the input section 20 is a touch panel capable of detecting multiple touches.

The input section 20 obtains, at predetermined time intervals, two-dimensional coordinate information (touch coordinates), on the input surface, of a finger of a user, an indicator, or the like which has been brought into contact with the input surface. The input section 20 transmits data of the obtained series of touch coordinates to an operation determination section 11 as a track of the touch coordinates.

Note that a configuration of the input section 20 and a method of detecting a touch operation by the input section 20 are not particularly limited to specific ones, provided that the input section 20 is capable of detecting at least two touches at predetermined time intervals. In a case where the input section 20 is capable of detecting a finger which is in the vicinity of the input surface, it is possible for the input section 20 to (i) obtain, instead of the touch coordinates, coordinates of a position of the finger in the vicinity of the input surface at predetermined time intervals and (ii) send the coordinates thus obtained to the operation determination section 11.

The storage section 40 stores various types of data (data such as a file and a program and data of an object such as an icon) to be used in the smartphone 1. As illustrate in FIG. 1, the storage section 40 stores a display list 41 and an arrangement pattern 42.

The display list 41 is information for determining display priorities based on which objects are displayed (i.e., determining an order in which objects are to be arranged) in the display section 30. More specifically, the display list 41 is information in which the display priorities are associated with pieces of information specifying the objects. The display list 41 is rewritten by an object storage section 13 (described later). Further, the display list 41 is read out by the display update section 14 (described later).

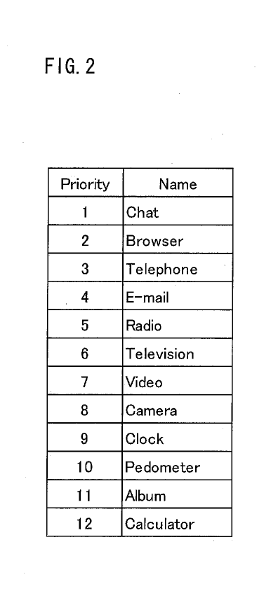

FIG. 2 shows an example of a data structure of the display list 41. As illustrated in FIG. 2, the display list 41 contains a “priority” column and a “name” column, and pieces of information in the “priority” column are associated with respective pieces of information in the “name” column. Note that the data structure of the display list 41 is not limited to a table format, and it is only necessary that the display list 41 be information in accordance with which the display priorities on the display screen can be specified.

The “priority” column stores pieces of information indicative of the display priorities based on which objects are displayed. The pieces of information may be freely changeable by a user. Further, the pieces of information can be stored in any format, provided that the display priorities can be uniquely determined in accordance with the pieces of information. For example, the priorities in the “priority” column do not necessarily need to be indicated by consecutive numbers.

The “name” column stores pieces of information respectively indicative of names of objects. Note that the pieces of information in the “name” column can be stored in any format, provided that the pieces of information are capable of uniquely indicating respective various objects.

The arrangement pattern 42 is information in which positions on the display screen of the display section 30 are associated with the respective display priorities of the objects. In other words, the arrangement pattern 42 is information defining positions on the display screen at which positions objects having respective given priorities are to be arranged. The arrangement pattern 42 does not particularly limit arrangement positions of the objects or an arranging method, provided that the arrangement positions of the objects are uniquely determined in accordance with the display priorities. Note that, according to Embodiment 1, the arrangement pattern 42 is defined in the following manner.

(Arrangement Pattern in Embodiment 1)

In Embodiment 1, the display screen of the display section 30 is divided into predetermined grid-like partitions and objects are arranged in the respective predetermined grid-like partitions in accordance with the display priorities. More specifically, for example, objects can be arranged in the respective partitions as follows: i.e., a first object having a highest priority (indicated by a smallest number in the “priority” column in the display list 41) is arranged in an upper-leftmost partition of the display screen; objects having lower priorities are arranged side by side toward right, in a descending order of priority, in respective partitions; and when an object is arranged in a rightmost partition in a row, another object having a priority immediately following that of the rightmost object is to be arranged in a leftmost partition in a next (lower) row. In this manner, the objects can be arranged until the display screen is filled with the objects.

The control section 10 comprehensively controls the smartphone 1. The control section 10 is realized by a CPU (central processing unit), for example. The control section includes the operation determination section 11 (operation determination unit), an object specifying section (range specifying unit, object specifying unit), the object storage section 13 (object storage unit), and the display update section 14.

The operation determination section 11 determines a type of operation carried out by a user with respect to the input section 20. Upon receipt of a track of touch coordinates from the input section 20, the operation determination section 11 determines, in accordance with the track, whether or not an operation carried out with respect to the input surface of the input section 20 is a pinch-in operation.

Note that the pinch-in operation refers to an operation to, while a plurality of fingers (or indicators) are in contact with the input surface, move the plurality of fingers toward an arbitrary point located between (or surrounded by) the plurality of fingers so that the plurality of fingers are brought together.

A method of determining, by the operation determination section 11, whether or not the pinch-in operation has been carried out is not limited to a particular one. For example, the operation determination section 11 can determine that the pinch-in operation has been carried out in a case where (i) there exist two sets of touch coordinates serving as starting points of tracks and (ii) the tracks indicated by touch coordinates are drawn so as to approach an arbitrary point located between two contact positions at the respective two sets of touch coordinates.

In a case where the operation determination section 11 has determined that an operation carried out by a user is the pinch-in operation, the operation determination section 11 transmits, to the object specifying section 12, the two sets of coordinates representing the starting points of the tracks, i.e., the starting points of the pinch-in operation.

The object specifying section 12 specifies an object (selected object) selected by the pinch-in operation. Upon receipt, from the operation determination section 11, of the two sets of coordinates representing the starting points of the pinch-in operation, the object specifying section 12 calculates a line segment connecting the two sets of coordinates. Further, the object specifying section 12 specifies, as a selected object, an object arranged at a position on the display screen through which position the calculated line segment passes. Then, the object specifying section 12 transmits information indicative of the selected object to the object storage section 13.

Note that, in a case where no object is arranged at the position on the display screen through which position the line segment passes, it is unnecessary for the object specifying section 12 to specify a selected object and transmit, to the object storage section 13, information indicative of the selected object. Alternatively, it is possible for the object specifying section 12 to transmit, to the object storage section 13, information indicating that there exists no selected object.

The object storage section 13 stores, in a folder, the selected object specified by the object specifying section 12. Upon receipt, from the object specifying section 12, of the information indicative of the selected object, the object storage section 13 creates a new folder in a hierarchy identical to that of the selected object, and stores, in the new folder, (i) the selected object or (ii) data with which the selected object is associated.

Note that the object storage section 13 can determine a type of selected object. A type of object refers to a classification of an object which classification is determined in accordance with an item indicated by the object. According to Embodiment 1, objects are classified into two types: i.e., (i) an object, such as a shortcut icon or a button, which is associated with a specific process and (ii) an object, such as a file icon or a folder icon, which indicates specific data itself. However, a method of classifying objects is not particularly limited to a specific one. Note that the type of object can be determined, for example, by referring to data (not shown) of an object which data is stored in the storage section 40 in accordance with information which is received from the object specifying section 12 and indicates a selected object.

For example, in a case where the selected object is an object associated with a specific process, the object storage section 13 can store the object itself in a created new folder. Meanwhile, in a case where the selected object is an object indicating specific data itself, the object storage section 13 can store, in the created new folder, data (i.e., a file itself) associated with the object (i.e., an icon of the file).

Further, in a case where the selected object is an object associated with a specific folder, the object storage section 13 can store, in the new folder, data stored in the specific folder and then delete the specific folder. Alternatively, the object storage section 13 can store, in the new folder, the specific folder itself while maintaining a hierarchical structure in the specific folder.

Further, the object storage section 13 updates the display list 41. Specifically, the object storage section 13 (i) deletes, from the display list 41, information indicative of specified objects, (ii) assigns, to the created new folder, a priority identical to that of an object having a highest display priority among the specified objects, and (iii) inserts information of the created new folder into the display list 41.

When the object storage section 13 has finished updating the display list 41, the object storage section 13 transmits, to the display update section 14, a control order for instructing the display update section 14 to update screen display.

Note that, after the object storage section 13 creates a new folder and stores a selected object in the new folder, the object storage section 13 can compress the new folder into a zip file, or the like.

It is possible to automatically determine, in accordance with the type of object, a name of a new folder to be created. For example, in a case where all of objects are music data, the name of the new folder can be set to be “music” or the like. A type of an object can be determined in accordance with an extension of the object.

In a case where the object storage section 13 has received, from the object specifying section 12, information indicating that there exists no selected object, the object storage section 13 can only create a new folder.

The display update section 14 determines an object to be displayed on the display screen and an arrangement of the object, and transmits information of the object and the arrangement of the object to the display section 30. Upon receipt, from the object storage section 13, of the control order instructing update of the screen display, the display update section 14 reads out, from the display list 41 in the storage section 40, a name of the object and a display priority of the object. Subsequently, the display update section 14 reads out, from the storage section 40, (i) image data (not shown) which is of the object and corresponds to the name of the object and (ii) an arrangement pattern 42. The display priority, the image data, and the arrangement pattern 42, which have been read out, are transmitted to the display section 30.

Note that, in a case where the storage section 40 stores an arrangement pattern of the object, the display update section 14 can transmit, to the display section 30, the arrangement pattern of the object in addition to the display priority and the image of the object.

<<Flow of Processes>>

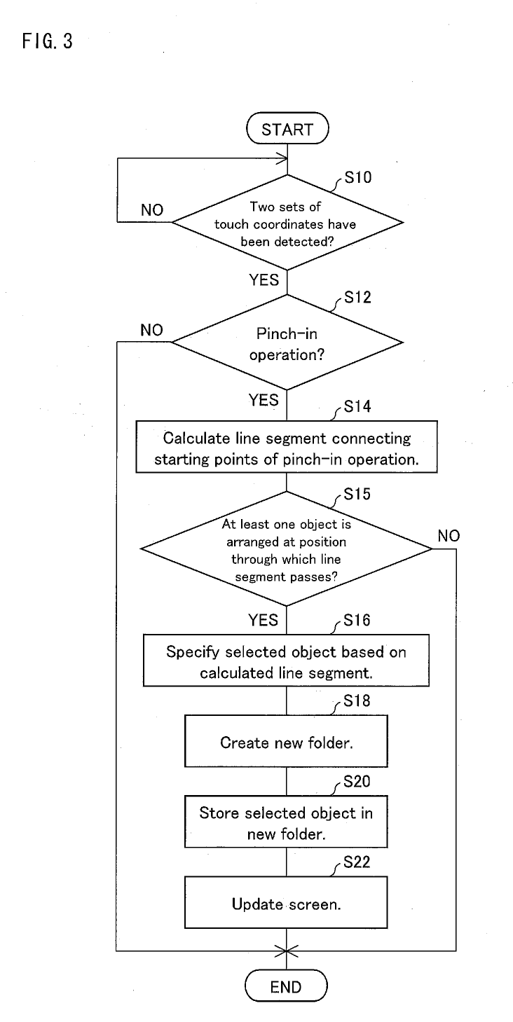

The following description discusses, with reference to FIG. 3, a flow of processes to be carried out by the smartphone 1. FIG. 3 is a flow chart showing the flow of processes to be carried out by the smartphone 1.

First, when a user has started an operation (touch operation) with respect to the input surface of the input section 20, the input section 20 accepts the operation and detects, at predetermined time intervals, coordinates (touch coordinates) of a position touched by the user. The input section 20 then transmits, to the operation determination section 11, series of touch coordinates as a track of the touch coordinates.

Upon receipt of the track of the touch coordinates from the input section 20, the operation determination section 11 first determines whether or not the track is tracks starting from respective two sets of touch coordinates (S10). In a case where the track is tracks starting from respective two sets of touch coordinates (YES in S10), the operation determination section 11 further determines, in accordance with the tracks starting from the respective two sets of touch coordinates, whether or not the operation carried out with respect to the input section 20 is the pinch-in operation (S12). In a case where the operation determination section 11 determines that the operation is the pinch-in operation (YES in S12), the operation determination section 11 transmits, to the object specifying section 12, the two sets of coordinates (i.e., starting points of the pinch-in operation) from which the respective tracks have started. Note that, in a case where the track received by the operation determination section 11 is a track which has started from only one point (NO in S10), processes subsequent to S10 are not carried out until the input section 20 detects two or more touches. In a case where the operation determination section 11 determines that the operation is not the pinch-in operation (NO in S12), the process is ended.

Next, upon receipt, from the operation determination section 11, of the coordinates representing the starting points of the pinch-in operation, the object specifying section 12 calculates a line segment connecting the two starting points of the pinch-in operation (S14). In a case where at least one object is arranged at a position on the display screen through which position the calculated line segment passes (YES in S15), the object specifying section 12 specifies the at least one object as a selected object (S16), and transmits information indicative of the selected object to the object storage section 13. Note that, in a case where no object is arranged at the position through which the calculated line segment passes (NO in S15), the process in S16 and subsequent processes are not carried out, and the process is ended here.

Subsequently, upon receipt, from the object specifying section 12, of the information indicative of the selected object, the object storage section 13 creates a new folder in a hierarchy identical to that of the selected object (S18), and stores, in the created new folder, the selected object or data corresponding to the selected object (S20). When the object storage section 13 has finished creating the folder and storing the object and the data, the object storage section 13 updates the display list 41, and transmits, to the display update section 14, a control order for instructing the display update section 14 to update screen display.

Lastly, upon receipt of the control order, the display update section 14 (i) reads out, from the display list 41, a display priority of an icon and (ii) transmits, to the display section 30, the display priority of the icon together with an image of the icon and an arrangement pattern 42 of the icon which have been read out from the storage section 40. The display section 30 (i) arranges, in accordance with the display priority of the icon and the arrangement pattern which have been received from the display update section 14, the image of the icon which has been also received from the display update section 14 and thus (ii) updates the display screen (S22).

By carrying out the processes described above, when the pinch-in operation carried out by a user has been detected, the smartphone 1 can calculate a line segment connecting starting points of the pinch-in operation and collectively specify, as objects to be stored (storage-target object), objects arranged at positions through which the line segment passes. In other words, by merely carrying out a pinch-in operation, the user can collectively select, from objects on the display screen, storage-target objects and store, in a new folder, the storage-target objects thus collectively selected. Therefore, according to the smartphone 1, it is possible to efficiently (i) select objects and (ii) store the objects in a folder, regardless of the number of objects to be selected.

Particularly, in a case where three or more objects are to be stored in a folder, it is possible to omit an operation to individually specify the three or more objects to be stored, and this reduces the number of operations to be carried out by a user. This makes it possible in an efficient manner to collectively specify objects and store the objects in a folder.

Moreover, in response to the pinch-in operation which makes a user intuitively think of “collecting” objects, the smartphone 1 can specify the objects and store the objects in a folder. Therefore, the user can store desired objects in the folder by carrying out an intuitive operation.

<<Example of Display Screen>>

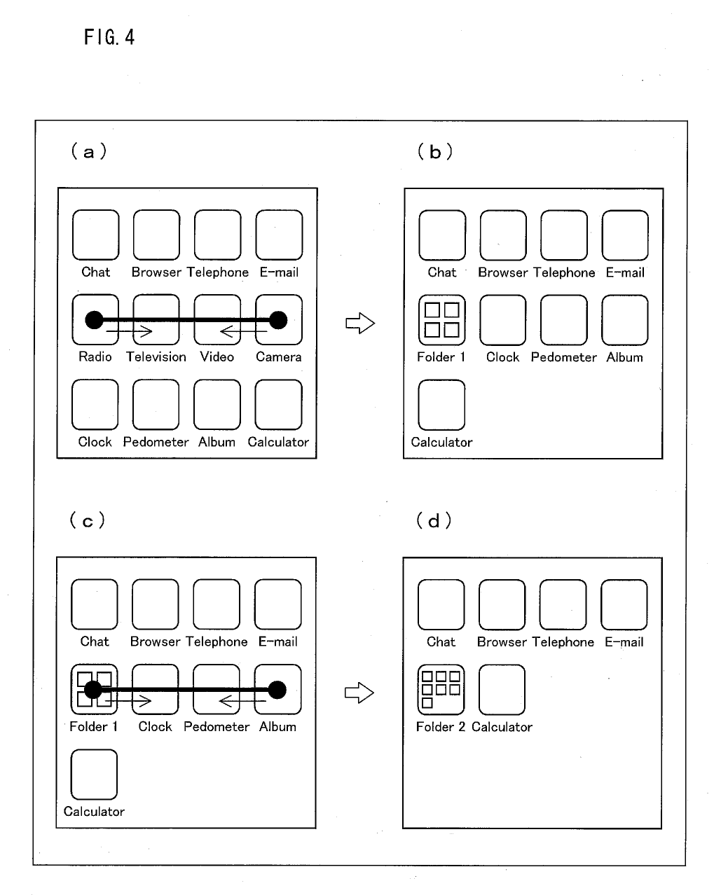

Lastly, the following description discusses, with reference to FIGS. 2 and 4, an operation and display control to be carried out by the smartphone 1. (a) and (c) of FIG. 4 illustrate display screens and operations to be carried out by a user with respect to the respective display screens. (b) and (d) of FIG. 4 illustrate the display screens which have been subjected to the operations illustrated in (a) and (c) of FIG. 4, respectively. Note that the display list 41 shown in FIG. 2 is a display list for displaying the display screen illustrated in (a) of FIG. 4.

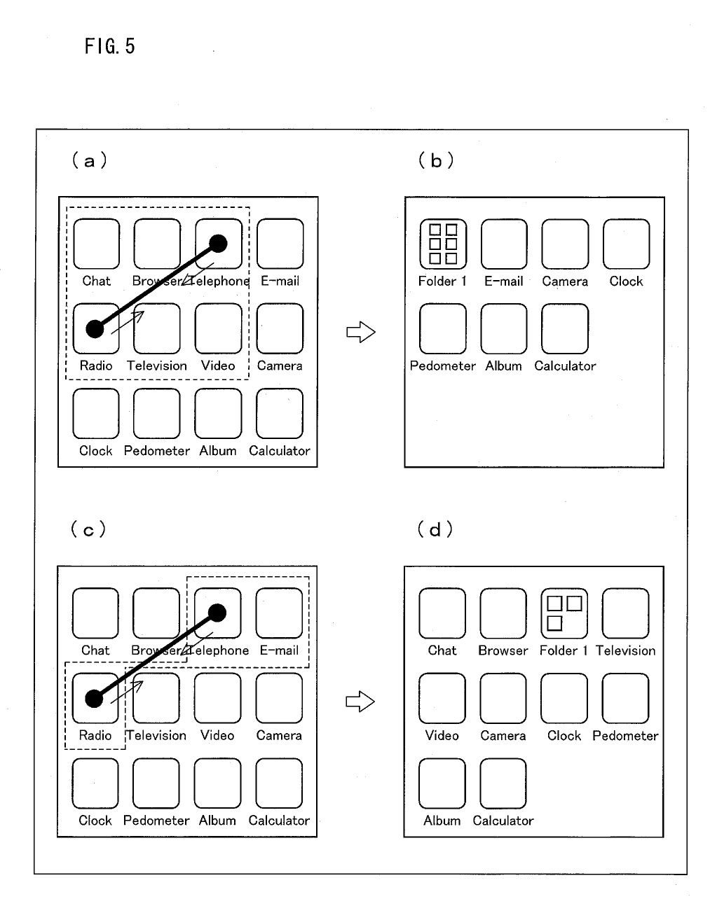

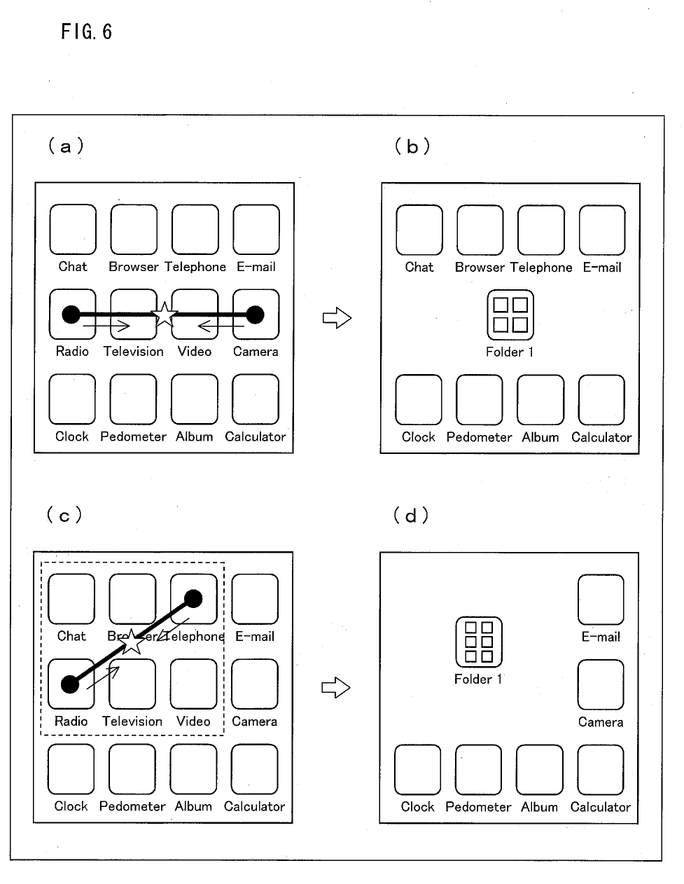

Black dots illustrated in each of (a) and (c) of FIG. 4 indicate starting points of a pinch-in operation carried out by the user. Arrows illustrated in each of (a) and (c) of FIG. 4 indicate directions in which the pinch-in operation has been carried out from the starting points. The same applies to FIGS. 5 and 6 (described later). The black dots, a line segment connecting the black dots, and the arrows illustrated in each of (a) and (c) of FIG. 4 schematically indicate the operation carried out by the user, and thus, these items do not need to be actually displayed on the display screen.

As illustrated in (a) of FIG. 4, shortcut icons are arranged in a matrix of 4 (vertical)×3 (horizontal) on the display screen of the display section 30. The following description discusses a case where a user has carried out a pinch-in operation on the display screen illustrated in (a) of FIG. 4. In this case, four shortcut icons “radio”, “television”, “video”, and “camera” are arranged at positions through which the line segment connecting two starting points of the pinch-in operation passes. From this, the object specifying section 12 specifies the four shortcut icons as selected objects, and transmits pieces of information indicative of the respective four shortcut icons to the object storage section 13. The object storage section 13 creates a new folder (folder 1) in a hierarchy identical to those of the four shortcut icons and stores, in the new folder thus created, data corresponding to the four shortcut icons.

The object storage section 13 then rewrites information in the display list 41. Specifically, the object storage section 13 (i) deletes pieces of information of the four shortcut icons from the display list 41, (ii) assigns, to a name of the new folder, a priority identical to that of the icon “radio”, which has a highest display priority among the four shortcut icons (so that information of the new folder in the “priority” column of the display list 41 becomes “5”), and (iii) inserts information of the name and the priority of the new folder into the display list 41. After that, the display update section 14 updates the display screen in accordance with the display list 41 thus updated. That is, the shortcut icons and the new folder are arranged in a Z-shape order from an upper-left partition of the display screen in a descending order of display priority.

As a result, as illustrated in (b) of FIG. 4, the new folder (folder 1) is arranged at a position at which the icon “radio” was located (i.e., at a position at which an object having a fifth display priority is displayed).

Meanwhile, (c) and (d) of FIG. 4 show the operation and the display control to be carried out by the smartphone 1 in a case where a folder icon is included in selected objects. An icon “folder 1” indicating a folder and eight other shortcut icons are displayed on the display screen illustrated in (c) of FIG. 4. The following description discusses a case where a user has carried out a pinch-in operation on the display screen as illustrated in (c) of FIG. 4. In this case, the icon “folder 1” and three shortcut icons “clock”, “pedometer”, and “album” are arranged at positions through which the line segment connecting the starting points of the pinch-in operation passes. From this, the object specifying section 12 specifies the icon “folder 1” and the three shortcut icons as selected objects. Subsequently, the object storage section 13 creates a new folder (folder 2) and stores, in the new folder thus created, the three shortcut icons “clock”, “pedometer”, and “album” and data stored in the “folder 1”. When the object storage section 13 has rewritten the information in the display list 41 and the display update section 14 has instructed the display section 30 to update the display screen, the new folder (folder 2) is arranged, as illustrated in (d) of FIG. 4, at a position at which the icon “folder 1” was located (i.e., at a position at which an object having a fifth display priority is displayed).

### Embodiment 2

According to Embodiment 1, the object specifying section 12 specifies, as a selected object, an object arranged at a position on the display screen through which position a line segment connecting two starting points of a pinch-in operation passes. However, a method of specifying the selected object is not limited to the method described above. Embodiment 2 describes, with reference to FIG. 5, another method of specifying a selected object. Note that, for convenience, members that have identical functions to those of Embodiment 1 are given identical reference numerals, and are not explained repeatedly. The same applies to Embodiment 3 and Modified Example.

(a) and (c) of FIG. 5 illustrate operations to be carried out by a user with respect to respective display screens. (b) and (d) of FIG. 5 illustrate the display screens which have been subjected to the operations illustrated in (a) and (c) of FIG. 5, respectively. Selected objects are surrounded by a dotted line in (a) and (c) of FIG. 5 (the same applies to subsequent drawings).

Note that, in FIG. 5, objects are arranged in a Z-shape order from an upper-left partition of the display screen in a descending order of display priority, as in FIG. 4.

In a case where a user has carried out an oblique pinch-in operation, the object specifying section 12 of the smartphone 1 can (i) calculate a rectangular region having a diagonal line which is a line segment connecting two starting points of the pinch-in operation and (ii) specify, as selected objects, objects arranged in the rectangular region. Specifically, for example, in a case where a user has carried out a pinch-in operation as illustrated in (a) of FIG. 5, the object specifying section 12 can specify, as selected objects, shortcut icons included in the rectangular region (i.e., a region surrounded by the dotted line in (a) of FIG. 5) having a diagonal line which is a line segment connecting two starting points (black dots) of the pinch-in operation. The object storage section 13 then creates a new folder (folder 1) storing the shortcut icons (icons “chat”, “browser”, “telephone”, “radio”, “television”, and “video”) and updates the display list 41. As a result, as illustrated in (b) of FIG. 5, the new folder (folder 1) is arranged at a position at which the icon “chat” was located (i.e., at a position at which an object having a first display priority is displayed).

Alternatively, in a case where a user has carried out an oblique pinch-in operation, the object specifying section 12 of the smartphone 1 can specify two objects corresponding to two starting points of the pinch-in operation and specify, as selected objects, (i) the two objects and (ii) an object having a display priority which is between priorities of the two objects.

For example, in a case where a user has carried out a pinch-in operation as illustrated in (c) of FIG. 5, objects corresponding to starting points of the pinch-in operation are icons “telephone” and “radio”. As described earlier, in (c) of FIG. 5, the objects are arranged from the upper-left position of the display screen in the descending order of display priority. Accordingly, the display priority of the icon “e-mail” is between priorities of the above two objects. Thus, the object specifying section 12 specifies the three icons “telephone”, “e-mail”, and “radio” as selected objects and creates a new folder storing the three icons. As a result, as illustrated in (d) of FIG. 5, the new folder (folder 1) thus created is arranged at a position at which the icon “telephone” was located (i.e., at a position at which an object having a third display priority is displayed).

### Embodiment 3

According to Embodiments 1 and 2, the arrangement positions of the objects to be displayed on the display screen are determined in accordance with (i) the display priorities of the objects which priorities are stored in the display list 41 and (ii) the arrangement pattern 42. Note, however, that the display list 41 and the arrangement pattern 42 are not essential to the present invention.

In a case where the display list 41 and the arrangement pattern 42 are not used, it is possible that an arrangement position of an object to be displayed is set for each object, and the arrangement position thus set is stored in the storage section 40. In this case, for example, it is possible that a blank area irregularly exists between objects. Alternatively, it is possible that a user arbitrarily changes arrangement positions of objects. In this case, a position at which a new folder created by the object storage section 13 is to be displayed can also be arbitrarily determined in accordance with a pinch-in operation carried out by the user. The following description discusses, with reference to FIG. 6, another example arrangement of objects and a created new folder on the display screen.

FIG. 6 illustrates an operation and display control to be carried out by the smartphone 1 in response to a user's operation in a case where the display list 41 and the arrangement pattern 42 are not used. (a) and (c) of FIG. 6 illustrate operations to be carried out by the user with respect to respective display screens. (b) and (d) of FIG. 6 illustrate the display screens which have been subjected to the operations illustrated in (a) and (c) of FIG. 6, respectively. Note that the operation illustrated in (a) of FIG. 6 is identical to the operation illustrated in (a) of FIG. 4, and the operation illustrated in (c) of FIG. 6 is identical to the operation illustrated in (a) of FIG. 5.

Star marks illustrated in (a) and (c) of FIG. 6 each indicate a point at which the user has brought fingers off from the display screen (i.e., the user has brought tips of the fingers together and moved the fingers off from the display screen when the pinch-in operation is carried out). The same applies to subsequent drawings.

For example, in a case where a user has carried out the operation illustrated in (a) or (c) of FIG. 6, the operation determination section 11 (i) calculates, in accordance with tracks of touch coordinates received from the input section 20, coordinates of the point at which the user has brought the fingers off from the display screen and (ii) transmits the calculated coordinates to the object specifying section 12. Then, selected objects are specified in a manner similar to those described in Embodiments 1 and 2, and the calculated coordinates are transmitted to the object storage section 13.

Subsequently, the object storage section 13 creates a new folder (folder 1) and stores the selected objects in the new folder. The object storage section 13 further determines that coordinates of an arrangement position of the new folder is coordinates whose center is a point at which the user has brought the fingers off from the display screen, and causes the storage section 40 to store the coordinates. The display update section 14 reads out, instead of the display list 41 and the arrangement pattern 42, the stored arrangement positions of the objects, and then transmits the arrangement positions to the display section 30. Thus, as illustrated in (b) and (d) of FIG. 6, the new folder created by the object storage section 13 is displayed at the point at which the fingers were brought off.

By carrying out the processes described above, it is possible to use an end point of the pinch-in operation as an arrangement position of the new folder. This makes it possible to display, at a user's desired position, a folder storing selected objects.

### Modified Example

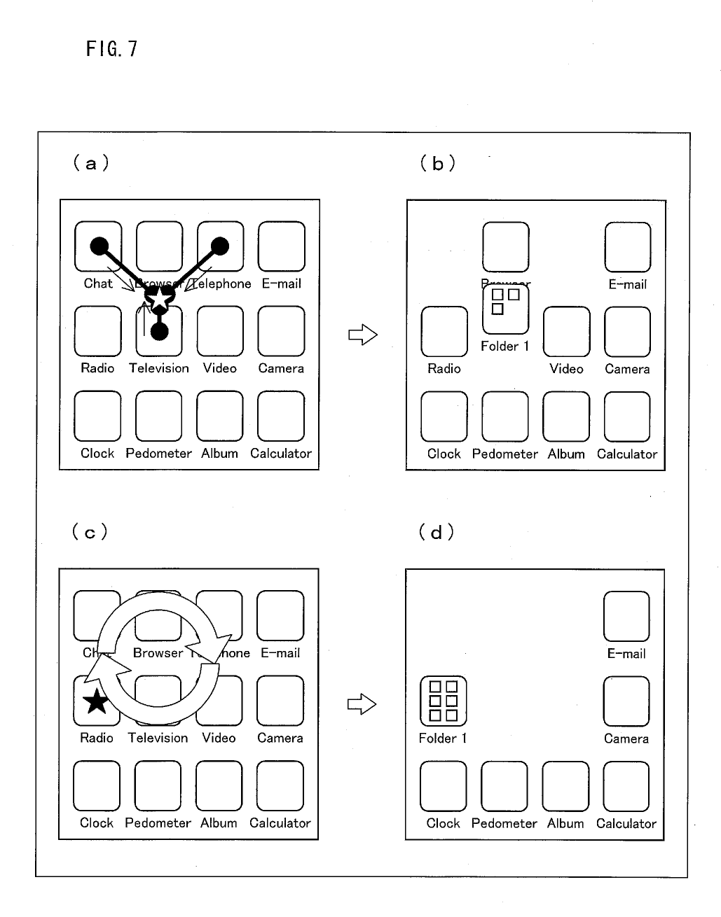

Note that a type of operation determined by the operation determination section 11 is not limited to the pinch-in operation described in Embodiments 1 through 3. FIG. 7 shows an example in which icons to be stored are specified in accordance with an operation different from that carried out by a user in Embodiments 1 through 3.

(a) and (b) of FIG. 7 each illustrate an operation to be carried out by the smartphone 1 in a case where the smartphone 1 detects that a user has carried out an operation to bring three fingers (or indicators) together. In this case, it is possible that (i) the input section 20 obtains tracks of touch coordinates of the three fingers and (ii) the operation determination section 11 calculates, in accordance with the tracks of the touch coordinates, a position (indicated by a star mark) at which the user has brought the fingers off from the display screen. Then, it is possible that (i) the object specifying section 12 specifies, as selected objects, icons (icons of “chat”, “telephone”, and “television”) arranged at positions through which the tracks of the touch coordinates of the three fingers pass and (ii) the object storage section 13 creates a folder storing the selected objects.

(c) and (d) of FIG. 7 each illustrate an operation to be carried out by the smartphone 1 in a case where the smartphone 1 has detected that a user's operation to move one finger so as to draw a circle (as indicated by an arrow) while the other finger is touching the input surface (at a black star mark). In this case, the operation determination section 11 separately transmits, to the object specifying section 12, (i) a track of points whose touch coordinates are changed (i.e., touch coordinates of the moved finger) and (ii) coordinates of a point whose touch coordinates are not changed (i.e., touch coordinates of the finger which is touching the input surface and is not moved). The object specifying section 12 (i) specifies, as selected objects, objects arranged at positions through which the track passes and (ii) transmits, to the object storage section 13, the coordinates of the point whose touch coordinates are not changed. The object storage section 13 can use, as an arrangement position of a created new folder, a position indicated by the coordinates received from the object specifying section 12.

As described above, the smartphone 1 preferably (i) specifies objects in accordance with an operation which makes the user intuitively think of “collecting” the objects and (ii) stores the objects in a folder. Therefore, in response to an intuitive operation carried out by the user, the smartphone 1 can specify user's desired objects and store the user's desired objects in the folder.

[Software Implementation Example]

Control blocks of the smartphone 1 (particularly, the object specifying section 12 and the object storage section 13) can be realized by a logic circuit (hardware) provided in an integrated circuit (IC chip) or the like or can be alternatively realized by software as executed by a CPU (Central Processing Unit).

In the latter case, the smartphone 1 includes a CPU that executes instructions of a program that is software realizing the foregoing functions; ROM (Read Only Memory) or a storage device (each referred to as “storage medium”) in which the program and various kinds of data are stored so as to be readable by a computer (or a CPU); and RAM (Random Access Memory) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Main Points]

An information processing apparatus (smartphone 1) in accordance with Aspect 1 of the present invention includes: a display section (display section 30) for displaying an object on a display screen; an input section (input section 20) for detecting a contact position of an indicator on the display screen; an operation determination unit (operation determination section 11) for determining whether or not a predetermined operation has been carried out, the predetermined operation having starting points which are at least two contact positions that have been detected by the input section; a range specifying unit (object specifying section 12) for, in a case where the operation determination unit has determined that the predetermined operation had been carried out, specifying a predetermined range on the display screen based on the at least two contact positions detected by the input section; an object specifying unit (object specifying section 12) for, in a case where at least one object is included in the predetermined range specified by the range specifying unit, specifying the at least one object as a storage-target object (selected object); and an object storage unit (object storage section 13) for, in a case where the object specifying unit has specified the storage-target object, (i) creating a folder for storing an object and (ii) storing, in the folder, the storage-target object thus specified.

According to the configuration, in a case where the operation determination unit has determined that a predetermined operation had been carried out from starting points which are at least two contact positions that are of indicators and have been detected by the input section, the range specifying unit specifies a predetermined range on the display screen based on the at least two contact positions detected by the input section. Further, in a case where at least one object is included in the predetermined range specified by the range specifying unit, the object specifying unit specifies the at least one object as a storage-target object Further, in a case where the object specifying unit has specified the storage-target object, the object storage unit creates a folder for storing an object and storing, in the folder, the storage-target object thus specified. According to the configuration, it is possible to collectively specify objects and store the specified objects in a folder by merely determining whether or not a predetermined operation has been carried out from starting points which are at least two contact positions that are of indicators and have been detected by the input section.

Since all of objects included in the predetermined range are determined to be storage-target objects, all of the objects included in the predetermined range can be stored in a newly created folder.

This makes it possible to provide an information processing apparatus capable of efficiently carrying out both of an operation to specify objects and an operation to store the objects in a folder, regardless of the number of objects to be specified.

In Aspect 2 of the present invention, the information processing apparatus in accordance with Aspect 1 can be configured such that the range specifying unit specifies the predetermined range on the display screen so that the predetermined range includes three or more objects.

According to the configuration, the range specifying unit specifies the predetermined range on the display screen so that the predetermined range includes three or more objects. Accordingly, the object specifying unit specifies, as storage-target objects, the three or more objects included in the predetermined range and the object storage unit stores the specified three or more objects in a folder. Thus, even in a case where the three or more objects are to be stored, it is determined whether or not the predetermined operation has been carried out and the three or more objects to be stored are collectively specified. Accordingly, it is possible to omit a conventional operation to individually specify objects to be stored in the folder. This makes it possible to reduce the number of operations to be carried out by a user, and thus it is possible in an efficient manner to collectively specify objects and store the objects in a folder.

In Aspect 3 of the present invention, the information processing apparatus in accordance with Aspect 1 or 2 can be configured such that the predetermined operation determined by the operation determination unit is an operation (pinch-in operation) to (i) bring a plurality of indicators into contact with the input section and (ii) move the plurality of indicators so that contact positions of the plurality of indicators come closer to an arbitrary point located between or surrounded by the contact positions.

According to the configuration, the information processing apparatus can specify the objects and store the objects in a folder in response to a pinch-in operation which makes a user intuitively think of “collecting” objects. Thus, in response to the intuitive operation carried out by the user, the information processing apparatus can specify user's desired objects and store, in the folder, the user's desired objects thus specified.

In Aspect 4 of the present invention, the information processing apparatus in accordance with Aspect 3 can be configured such that the range specifying unit specifies the predetermined range based on a line segment connecting the contact positions detected by the input section.

According to the configuration, the object specifying unit can specify objects through which a line segment connecting starting points of a pinch-in operation passes on the display screen. That is, the object specifying unit can specify objects located on the line segment connecting starting points of the pinch-in operation carried out by a user.

Therefore, in response to an operation which is carried out by a user and is more intuitive to the user, the information processing apparatus can efficiently specify appropriate objects.

In Aspect 5 of the present invention, the information processing apparatus in accordance with any one of Aspects 1 through 3 can be configured such that the input section further detects a track of a contact position on the display screen; and the range specifying unit specifies the predetermined range based on the track of the contact position detected by the input section.

According to the configuration, the predetermined range is specified based on the track of the contact position detected by the input section. Therefore, in response to an operation which is carried out by a user and is more intuitive to the user, the information processing apparatus can efficiently specify appropriate objects.

A control program in accordance with Aspect 6 of the present invention is a control program for causing a computer to function as an information processing apparatus including (i) a display section for displaying an object on a display screen and (ii) an input section for detecting a contact position of an indicator on the display screen, the control program causing the computer to execute: an operation determination step (S12) of determining whether or not a predetermined operation has been carried out, the predetermined operation having starting points which are at least two contact positions that have been detected by the input section; a range specifying step (S14) of, in a case where it has been determined in the operation determination step that the predetermined operation had been carried out (YES in S12), specifying a predetermined range on the display screen based on the at least two contact positions detected by the input section; an object specifying step (S16) of, in a case where at least one object is included in the predetermined range specified in the range specifying step (YES in S15), specifying the at least one object as a storage-target object (selected object); and an object storage step (S20) of, in a case where the storage-target object has been specified in the object specifying step, (i) creating a folder for storing an object (S18) and (ii) storing, in the folder, the storage-target object thus specified.

The configuration brings about an effect similar to that of the information processing apparatus. Note that the present invention encompasses a computer-readable storage medium storing the control program therein.

A method of controlling an information processing apparatus in accordance with Aspect 7 of the present invention is a method of controlling an information processing apparatus including (i) a display section for displaying an object on a display screen and (ii) an input section for detecting a contact position of an indicator on the display screen, the method including the steps of: (a) determining whether or not a predetermined operation has been carried out (S12), the predetermined operation having starting points which are at least two contact positions that have been detected by the input section; (b) specifying, in a case where it has been determined in the step (a) that the predetermined operation had been carried out (YES in S12), a predetermined range on the display screen based on the at least two contact positions detected by the input section (S14); (c) specifying, in a case where at least one object is included in the predetermined range specified in the step (b) (YES in S15), the at least one object as a storage-target object (selected object) (S16); and (d) creating a folder for storing an object (S18) and storing, in the folder, the storage-target object (S20), in a case where the storage-target object has been specified in the step (c).

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to an electronic device including a touch panel. Specifically, the present invention is suitably applicable to a smartphone and a tablet information terminal, and the like.

### REFERENCE SIGNS LIST

1: Smartphone (information processing apparatus); 11: Operation determination section (operation determination unit); 12: Object specifying section (object specifying unit); 13: Object storage section (object storage unit); 20: Input section (detection unit); 30: display section

1. An information processing apparatus comprising:
a display section for displaying an object on a display screen;
an input section for detecting a contact position of an indicator on the display screen;
an operation determination unit for determining whether or not a predetermined operation has been carried out, the predetermined operation having starting points which are at least two contact positions that have been detected by the input section;
a range specifying unit for, in a case where the operation determination unit has determined that the predetermined operation had been carried out, specifying a predetermined range on the display screen based on the at least two contact positions detected by the input section;
an object specifying unit for, in a case where at least one object is included in the predetermined range specified by the range specifying unit, specifying the at least one object as a storage-target object; and
an object storage unit for, in a case where the object specifying unit has specified the storage-target object, (i) creating a folder for storing an object and (ii) storing, in the folder, the storage-target object thus specified.

2. The information processing apparatus as set forth in claim 1, wherein the range specifying unit specifies the predetermined range on the display screen so that the predetermined range includes three or more objects.

3. The information processing apparatus as set forth in claim 1, wherein the predetermined operation determined by the operation determination unit is an operation to (i) bring a plurality of indicators into contact with the input section and (ii) move the plurality of indicators so that contact positions of the plurality of indicators come closer to an arbitrary point located between or surrounded by the contact positions.

4. The information processing apparatus as set forth in claim 3, wherein the range specifying unit specifies the predetermined range based on a line segment connecting the contact positions detected by the input section.

5. The information processing apparatus as set forth in claim 1, wherein:
the input section further detects a track of a contact position on the display screen; and
the range specifying unit specifies the predetermined range based on the track of the contact position detected by the input section.

6. A method of controlling an information processing apparatus including (i) a display section for displaying an object on a display screen and (ii) an input section for detecting a contact position of an indicator on the display screen,
said method comprising the steps of:
(a) determining whether or not a predetermined operation has been carried out, the predetermined operation having starting points which are at least two contact positions that have been detected by the input section;
(b) specifying, in a case where it has been determined in the step (a) that the predetermined operation had been carried out, a predetermined range on the display screen based on the at least two contact positions detected by the input section;
(c) specifying, in a case where at least one object is included in the predetermined range specified in the step (b), the at least one object as a storage-target object; and
(d) creating a folder for storing an object and storing, in the folder, the storage-target object, in a case where the storage-target object has been specified in the step (c).
